(19) United States
(12) Patent Application Publication
(10) Pub. No.: US 2009/0108022 A1
(43) Pub. Date: Apr. 30, 2009

(54) LIQUID DISPENSING APPARATUS

(76) Inventor: DAVID Thomas HUGGINS, The Patch (AU)

Correspondence Address: DICKSTEIN SHAPIRO LLP, 1825 EYE STREET NW, Washington, DC, 20006-5403, US

(21) Appl. No.: 12/257,153

(22) Filed: Oct. 23, 2008

(30) Foreign Application Priority Data
Oct. 24, 2007 (AU) 2007101030
Dec. 12, 2007 (AU) 2007101181

(51) Int. Cl. B67B 5/00; B65D 5/72

(52) U.S. Cl. 222/153.04; 222/567; 222/455

(57) ABSTRACT

A liquid dispensing apparatus, including: an expandable member for defining a first chamber and a second chamber in a cavity of a container, said first chamber being adapted for storing a liquid; and a body having a passage formed through the body for accessing said first chamber, said body having a sealing portion for forming a seal around an opening to said cavity, said body having a valve that is selectively adjustable by a user to a closed position for inhibiting a flow of fluid through said passage; wherein only when said body is placed in a pouring position, said valve is adjustable by a user to an open position to allow said liquid to be displaced from said first chamber via said passage when the second chamber expands.

### FIELD

The present invention relates to a liquid dispensing apparatus.

### BACKGROUND

Certain liquids (and in particular edible liquids, such as wine, oil and vinegar) may react with the surrounding air over time, which may deteriorate the quality or character of the liquid and its suitability for use or consumption. For example, wine reacts with oxygen in the air which (within a short period of time) can alter the original flavour of the wine. Similarly, liquids such as paint gradually evaporate when exposed to air for extended periods of time, thus becoming unusable. It is therefore desirable to store such liquids in an environment that minimises its contact with air to help preserve its effective (e.g. usable or consumable) life.

Sealing devices (such as corks, plastic bottle stoppers and screw caps) may be used to form a seal around an opening of the container. In the process of fitting such sealing devices to a container, a small amount of air may be trapped inside the container (e.g. when a cork is plugged into the opening of a wine bottle). The trapped air becomes compressed and in turn applies positive pressure resisting against the seal formed between the sealing device and the container. If the amount of air trapped in the container is significant, the air may react with the liquid and cause it to go off prematurely.

Another problem is that when the sealing device is removed from the container, air enters the container when the liquid is displaced from the container. However, some liquid may remain in the container that needs to be stored for future consumption. For example, in catering scenarios, it may be necessary to open several bottles of wine to customers. The customers may not always consume a full bottle of wine, thus leaving some wine remaining in the bottles. Once air has entered the container, it is difficult to expel this air before resealing the container (e.g. to keep the remaining liquid fresh by minimising its further contact with air). Devices have been developed to assist pouring of liquids from containers whilst minimising spillage and to seal the container after use. Such devices typically include some form of cap or closure (e.g. a cork or stopper) to seal the contents of the container. Some of these devices have a lever system added to the cap with a spring loaded against the seal that presses hard against an opening of the container to prevent the contents from leaking out and to stop air from entering, but the air inside the container is not removed or replaced. Such devices seal a container with air and liquid still inside, and are not useful for sealing a container holding a liquid such as wine since the air inside the container will react with and change the flavour of the wine.

U.S. Pat. No. 7,051,901 describes a liquid dispensing apparatus fitted to an opening of a container holding a liquid. The apparatus has a user-operated valve for controlling the flow of liquid from the container. An inflatable balloon is placed inside the container. Once liquid is displaced from the container, the balloon is inflated with air (e.g. using a pump) to raise the level of the liquid in the container before closing the valve, thus minimising air from contacting the liquid remaining inside the container. However, the apparatus traps air inside the container when it is fitted to the container. Also, the valve of the apparatus can be inadvertently opened so as to let air come into contact with the liquid stored in the container.

It is desired to address one or more of the above problems, or to at least provide a useful alternative to existing apparatuses for controlling the dispensing of a liquid from a container.

### SUMMARY

According to the present invention, there is provided a liquid dispensing apparatus, including:
an expandable member for defining a first chamber and a second chamber in a cavity of a container, said first chamber being adapted for storing a liquid; and
a body having a passage formed through the body for accessing said first chamber, said body having a sealing portion for forming a seal around an opening to said cavity, said body having a valve that is selectively adjustable by a user to a closed position for inhibiting a flow of fluid through said passage;
wherein only when said body is placed in a pouring position, said valve is adjustable by a user to an open position to allow said liquid to be displaced from said first chamber via said passage when the second chamber expands.

Preferably, the seal formed around the opening substantially inhibits a flow of gas between the sealing portion and the opening (e.g. is substantially air-tight). This allows the liquid to be stored in the first chamber without contact to another substance, such as the air surrounding the container. To enable a volume of liquid to be displaced from the first chamber, the second chamber is allowed to expand. For example, the second chamber may expand by receiving a substance (e.g. air) external to the container. The expandable member also forms a barrier so as to inhibit the substances stored in the first and second chambers respectively from mixing with each other.

The liquid dispensing apparatus helps control the dispensing of a liquid stored inside the container, whilst minimising exposure of the liquid (stored in the first chamber) to a substance (e.g. air surrounding the container) in order to help preserve the effective life of the liquid. A user can selectively adjust the valve between the open and closed positions by moving a drive member (e.g. with the user's thumb or finger) to selectively control the flow of liquid from the container through the body and out through a spout opening.

Further, the liquid dispensing apparatus may include a lock member that moves or pivots inside the body of the apparatus. The lock member moves to a position that allows the drive member to open the valve only when the body (e.g. together with the container) is tilted to a pouring angle or pouring position. Otherwise, the lock member is in a position that inhibits the operation of the drive member to open the valve. By having the lock member, it becomes more difficult to inadvertently open the valve (by operating the drive member) when the container and the body of the apparatus is not placed in a pouring position.

### BRIEF DESCRIPTION OF THE DRAWINGS

Preferred embodiments of the present invention are herein described, by way of example only, with reference to the accompanying drawings, wherein:

FIG. 1 is a diagram of a body of a liquid dispensing apparatus;

FIG. 2 is an exploded perspective view of the body;

FIG. 3 is an exploded side view of the body;

FIGS. 4A and 4B are top and cross-sectional views of a tap body member of the apparatus;

FIGS. 5A, 5B and 5C are side, front and cross-sectional views of an alternative body;

FIGS. 6A and 6B are exploded perspective views of the alternative body;

FIGS. 7A, 7B, 7C, 7D and 7E are front, bottom, cross-sectional, side and another—sectional view of a spout member of the apparatus;

FIGS. 8A and 8B are side and cross-section views of a sealing member of the apparatus;

FIGS. 9A and 9B are perspective and exploded perspective views of a flow control mechanism of the apparatus;

FIG. 10 is a perspective view of a lock member of the apparatus;

FIGS. 11A, 11B and 11C are front, side and top views of an actuating member of the apparatus;

FIG. 12A is a cross-sectional view of the body in a normal standing position; and

FIG. 12B is a cross-sectional view of the body in a pouring position.

### DETAILED DESCRIPTION OF THE REPRESENTATIVE EMBODIMENTS

A liquid dispensing apparatus includes a body 100 for fitting into (or around) an opening of a container. The container has a storage cavity, and preferably has only one opening providing access to the storage cavity. The liquid dispensing apparatus includes an expandable member 140 (not shown) that is placed inside the storage cavity of the container.

The expandable member 140 defines a first chamber and second chamber within the storage cavity. For example, the second chamber may refer to the space occupied by the expandable member 140 (when placed inside the storage cavity), and the first chamber may refer to the remaining space within the storage cavity of the container that is not already occupied by the expandable member 140, or vice versa. In this specification, the second chamber refers to the space occupied by the expandable member 140 inside the storage cavity. The first chamber is adapted for storing a liquid (such as wine, oil, vinegar etc). The second chamber is allowed to expand when a volume of liquid is displaced from the first chamber. The expandable member 140 includes any form of deformable container suitable for containing a fluid (e.g. a gas or liquid), such as a plastic bag or balloon. The wall of the expandable member 140 serves as a barrier for inhibiting the transfer of a substance between the first and second chambers.

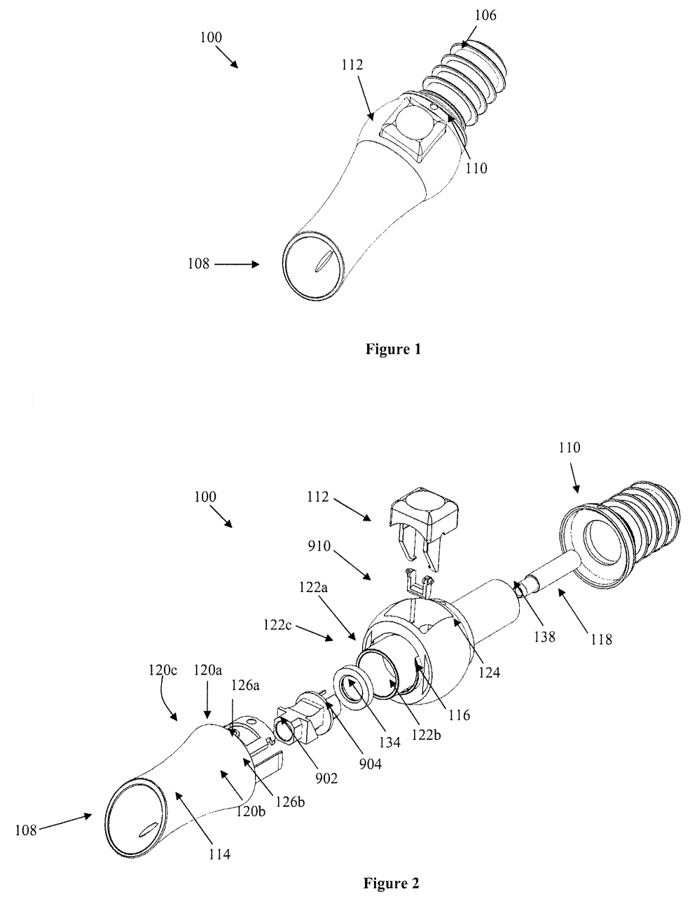

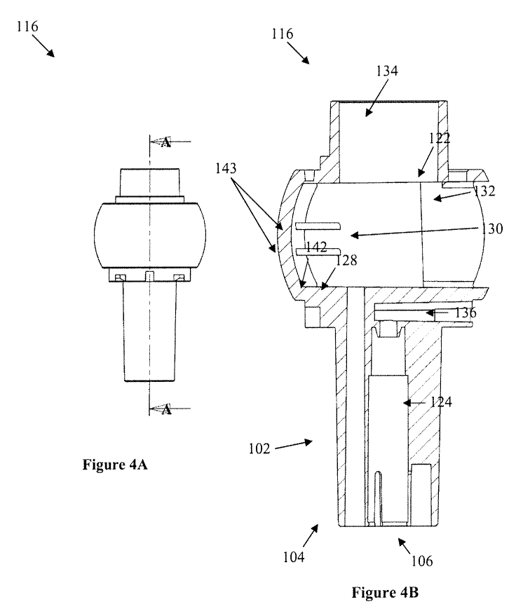

FIG. 1 shows a representative embodiment of the body 100 for fitting into an opening of a container. When the body 100 is fitted into the opening, the sealing portion 110 of the body 100 engages a surface around the opening of the container (to the storage cavity) to form a seal that inhibits a flow of fluid (e.g. liquid or gas) between the body 100 and the opening of the container. For example, the sealing portion 110 may form a substantially air-tight seal that resists a flow of air (surrounding the outside of the container) into the storage cavity of the container via the opening. The liquid stored in the first chamber of the container is received into a passage 102 formed through the body 100 via an internal intake opening 104 (see FIGS. 4B and 12A) located at a receiving end 106 of the body 100. The fluid can flow through the passage 102 to be poured out of the body 100 via a spout opening 108.

The body 100 includes a flow control mechanism 900 that is adjustable by an actuating member 112 under the control of a user. When a user selectively adjusts the actuating member 112, the flow control mechanism 900 adjusts the position of a valve located within the body 100 to control a flow of a fluid (e.g. any liquid or gas) through the passage 102. For example, when a user pushes the actuating member 112 in towards the body 100, the flow control mechanism 900 adjusts the valve to an open position to allow liquid from the first chamber of the container to flow through the passage 102 and out through the spout opening 108, and also allow the second chamber to expand in volume. When the user releases the actuating member 112, the valve returns to a closed position for inhibiting a flow of liquid from the first chamber of the container through the passage 102. The valve in the close position also inhibits ingress of a fluid from outside of the container (e.g. the air surrounding the container) into the first chamber of the container via the passage 102.

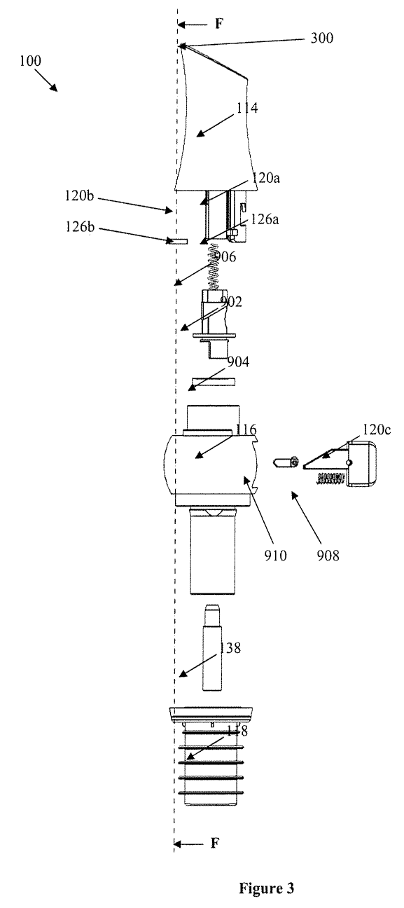

FIGS. 2 and 3 are exploded perspective and side views of the body 100 shown in FIG. 1. As shown in FIGS. 2 and 3, the body 100 is made up of a spout member 114, tap body member 116 and sealing member 118 when releasably coupled together. The spout member 114 couples to one end of the tap body member 116, and the sealing member 118 fits over and couples to a neck portion 124 of the tap body member 116. The tap body member 116 has an access opening 132 and a passage opening 134 for accessing an operating chamber 130 formed inside the tap body member 116 for housing the flow control mechanism 900.

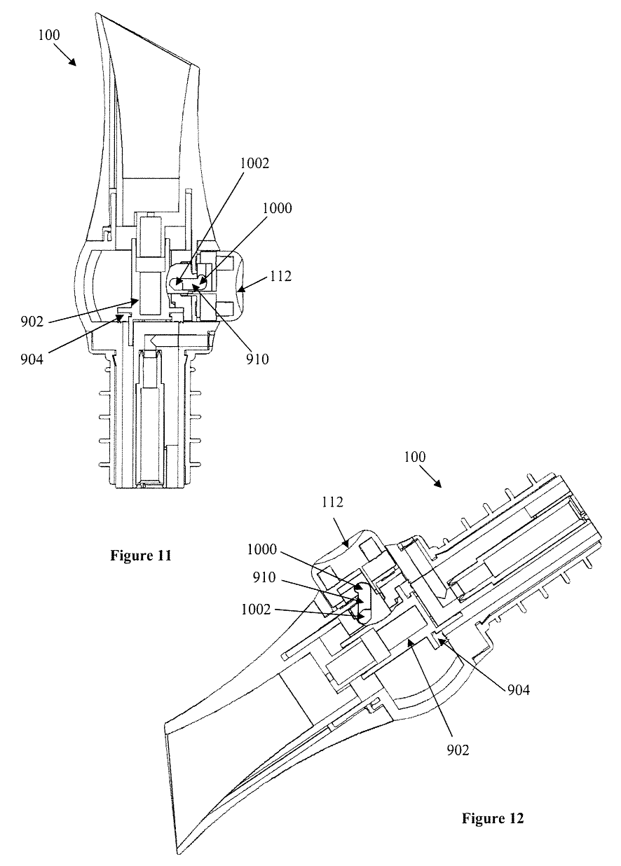

FIGS. 2 and 3 also show the components of the flow control mechanism 900, which includes a plunger 902, valve sealing member 904, primary biasing means 906, actuating member 112, secondary biasing means 908, and a lock member 910. The operation of the flow control mechanism 900 is described in greater detail below with reference to FIG. 9.

FIG. 4A is a bottom view of the tap body member 116. FIG. 4B is a cross-sectional view of the tap body member 116 (along section A-A in FIG. 4A). FIG. 4B shows a portion of the passage 102 that extends internally along the tap body member 116. The passage 102 begins at the internal intake opening 104 and extends to the passage opening 134, where the passage 102 continues on through the spout member 114 to the spout opening 108. The operating chamber 130 for housing the flow control mechanism 900 forms part of the passage 102, and is located between the internal intake opening 104 and passage opening 134. The tap body member 116 has two support flanges 143 that interacts with the end portions 916 (see FIG. 9B) of the actuating member 112 to guide the movement of the actuating member 116.

As shown in FIG. 4B, the tap body member 116 has an external intake opening 136. In a representative embodiment, the expandable member 140 is in fluid communication with the external intake opening 136 via a conduit 138. The conduit 138 has a tubular body that extends through a portion of the body 100 to be in fluid communication with the external intake opening 136. The tap body member 116 and expandable member 140 respectively engage opposite ends of the conduit 138, and preferably, such engagement forms a substantially air-tight with the conduit 138. In this configuration, a substance external to the container (e.g. air) is able to enter and inflate the second chamber defined inside the container when a volume of liquid is displaced from the first chamber of the container.

In another representative embodiment, the tap body member 116 does not have an external intake opening 136, and the expandable member 140 is placed inside the storage cavity of the container without being connected to the tap body member 116. In this configuration, the expandable member 140 may contain a substance that positively causes the expandable member 140 to increase in volume (e.g. by generating a gas) when a volume of liquid is displaced from the first chamber of the container.

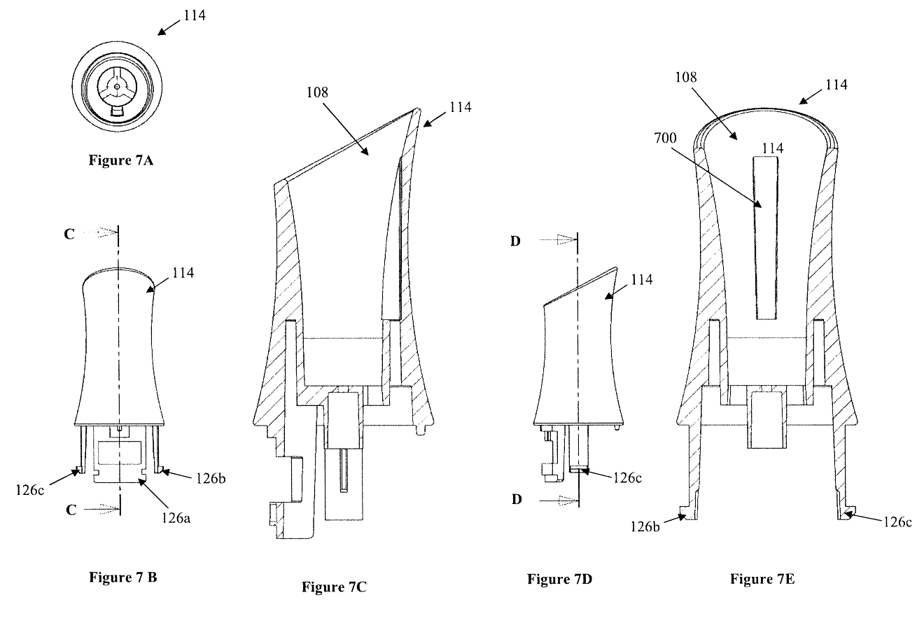

FIGS. 7A, 7B, 7C, 7D and 7E show different aspects of the spout member 114 in greater detail. FIG. 7A is a front view of the spout member 114. FIG. 7B is a bottom view of the spout member 114, and shows the enlarged head portions 126a, 126b and 126c. FIG. 7C is a cross-sectional view of the spout member 114 (along section C-C in FIG. 7B). FIG. 7D is a side view of the spout member 114. FIG. 7E is a cross-sectional view of the spout member 114 (along section D-D in FIG. 7D).

The spout member has one or more connecting flanges 120a, 120b and 120c, each of which may have an enlarged end portion 126a, 126b and 126c (see FIGS. 7B and 7E). When the connecting flanges 120a, 120b and 120c are received into corresponding apertures 122a, 122b and 122c formed in the tap body member 116, the enlarged head portions 126a, 126b and 126c resist disengagement of the flanges 120a, 120b and 120c from the apertures 122a, 122b and 122c, and as a result securely holds the spout member 114 and tap body member 116 together.

As shown in FIG. 7E, the spout member 114 also has a drainage path 700 that is in fluid communication with the operating chamber 130. After the valve has been adjusted to a close position, some liquid may still reside in the operating chamber 130 of the tap body member 116. The drainage path 700 allows any remaining liquid trapped in the operating chamber 130 (after the valve is adjusted to a closed position) to be poured out via the spout opening 108.

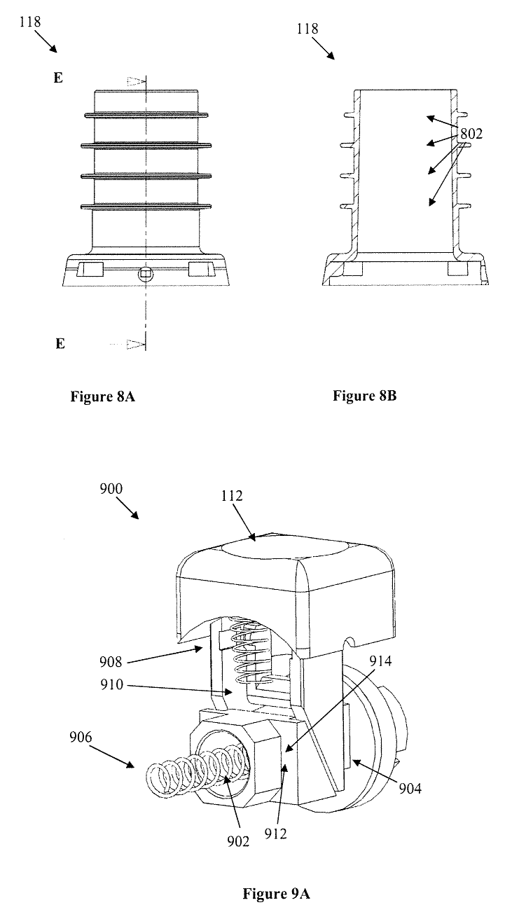

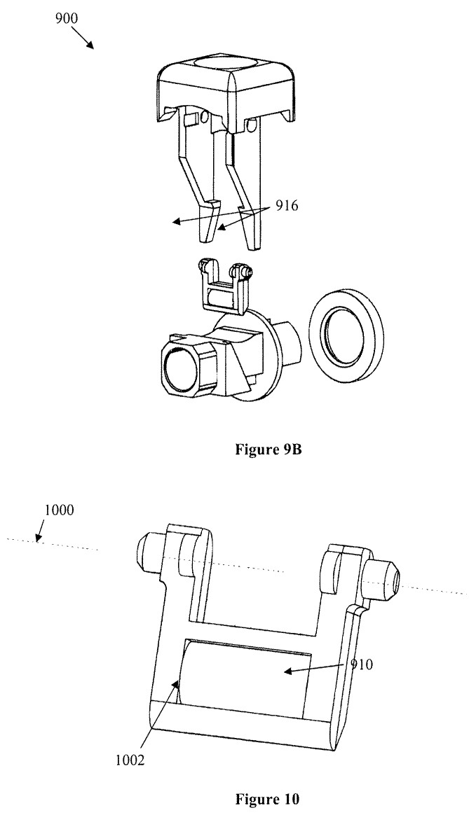

FIG. 8A is a bottom view of the sealing member 118. FIG. 8B is a cross-sectional view of the sealing member 118 (along section E-E in FIG. 8A). The sealing member 118 shown in FIGS. 8A and 8B is shaped for fitting into an opening of the container providing access to the storage cavity. The sealing member 118 has a hollow core 804 for receiving the neck portion 124 of the tap body member 116. The sealing member 118 has (on its outer surface) one or more flexible flange portions 802 that project away from the body 100 when the sealing member 118 is fitted to the tap body member 116.

When the sealing member 118 is fitted into the opening of the container, the flexible flange portions 134 deform in shape (e.g. bends) so as to form a seal with a surface of the container around the opening. Referring to FIG. 8B, for example, the sealing member 118 is inserted into an opening of the container by moving in an upward direction (relative to the page). As a result, the flexible flange portions 134 will deform or bend towards a downward direction as a result of the flexible flange portions 134 being pushed in a direction opposite to the direction in which the body 100 is inserted into the opening. In this way, the flexible flange portions 134 form a seal with an inner surface of the container (adjacent to the opening) that inhibits a flow of fluid (e.g. gas or liquid) between the flexible flange portions 134 and the inner surface of the container.

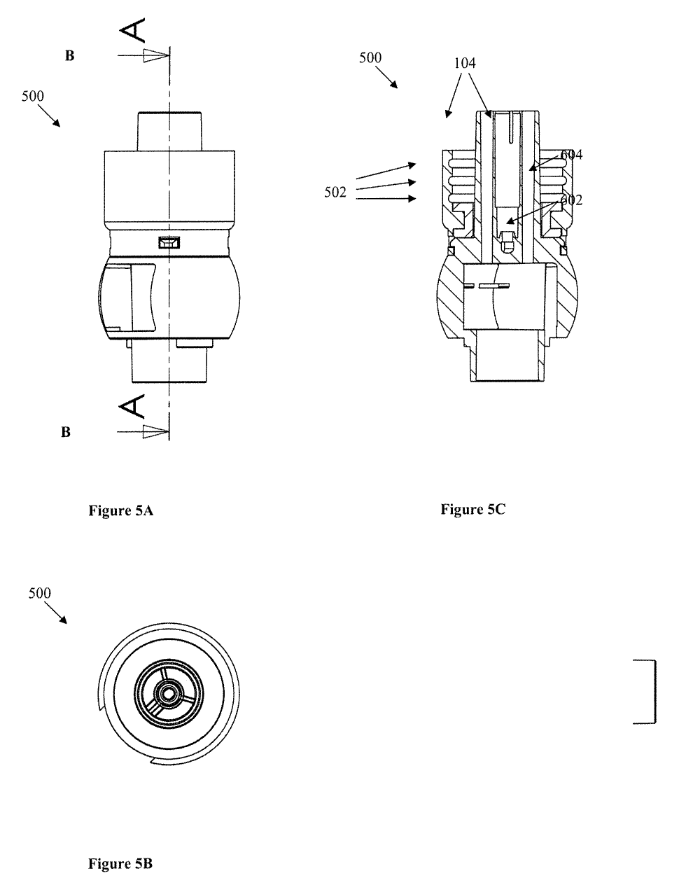

FIGS. 5A, 5B and 5C relate to another representative embodiment of the body 500 for fitting around an opening of a container (e.g. a container designed for use with a screw cap seal). FIG. 5A is a side view of the body 500. FIG. 5B is a cross-sectional view of the body 500 (along section B-B in FIG. 5A). FIG. 5C is a front view of the body 500.

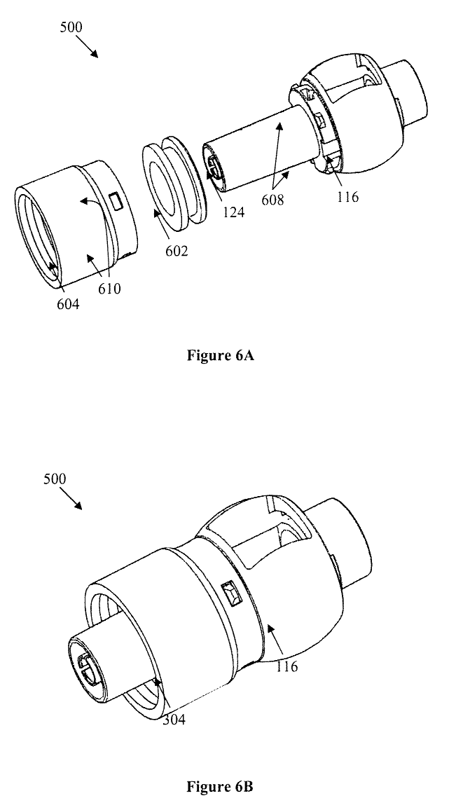

FIG. 6A is an exploded perspective view of the components of the body 500. FIG. 6B is an exploded view of the components of the body 500 when assembled. The body 500 shown in FIGS. 5A, 5B, 5C, 6A and 6B is to be coupled to a spout member 114 as shown in FIGS. 2 and 3 (but which is not shown in FIGS. 5A, 5B, 5C, 6A and 6B).

As shown in FIG. 6A, the body 500 a tap body member 116 (which is the same tap body member 116 shown in FIGS. 2, 4A and 4B). The body 500 includes a sealing member 602 and a cap member 604. The sealing member 602 is ring shaped, and has a hollow centre portion for receiving the neck portion of the tap body member 116. The cap member 604 has is tubular in shape, and has a threaded inner surface 502 (see FIG. 5C) for securely engaging a correspondingly threaded portion around the opening of the container. The tap body member 116 has one or more outwardly projecting flange members 608 for being received into corresponding apertures 610 formed on the cap member 604. The flange members 608 are shaped for positively engaging the apertures 610 so as to resist disengagement of the cap member 604 from the tap body member 116.

To assemble the body 500 from the components shown in FIG. 6A, first the sealing member 602 is fitted over the neck portion 124 of the tap body member 116. The cap member 604 is then fitted over the neck portion 124 of the neck portion of the tap body member 116, so that flange members 608 are fitted into (and engage) the corresponding apertures 610. The tap member 116 is then coupled to the spout member 114 in the same manner as described with reference to FIGS. 2 and 3. The body 500 when assembled (without the spout portion 114) is shown in FIG. 6B.

To fit the body 500 to the container, the body 500 is rotated so that the threaded inner surface 502 of the body 500 follows a correspondingly threaded portion around the opening of the container. This resulting secure engagement that is formed between the threaded inner surface 502 and the threaded portion of container resists decoupling of the body 500 from the container. As the body 500 is rotated along the threaded portion of the container, a lip portion of the container pushes against the sealing member 602 so as to form a seal that inhibits a flow of fluid (e.g. liquid or gas) between the body 100 and the opening of the container (similar to the function of the sealing portion 118 of the body 100 shown in FIGS. 2 and 3).

FIG. 9A is a perspective view of a flow control mechanism 900 that operates inside the operating chamber 130 of the tap body member 116. FIG. 9B is an exploded perspective view of some of the components of the flow control mechanism 900. Referring to FIG. 9A, the flow control mechanism 900 includes a plunger 902 that is coupled to a valve sealing member 904. The valve sealing member 904 may be an O-ring. In a representative embodiment, the plunger 902 and valve sealing member 904 are moveable along an axis 300 that runs along the length of the body 100.

As shown in FIG. 4B, operating chamber 130 has a wall portion 142 around a valve opening 128. Liquid received into the internal intake opening 104 can flow through the valve opening 128 and into the operating chamber 130. The valve sealing member 904 forms a valve with the wall portion 142 around the valve opening 128. The valve is in a closed position when the plunger 902 is positioned so that the valve sealing member 904 engages (or comes into contact with) the wall portion 142 (for inhibiting a flow of fluid through the passage 102). The valve is in an open position when the plunger 902 is positioned so that the valve sealing member 904 disengages (or separate) from the wall portion 142 around the valve opening 128 (for allowing liquid from the first chamber of the container to flow through the passage 102). The flow control mechanism 900 includes primary biasing means 906 for biasing the plunger 902 and valve sealing member 904 to move towards the wall portion 142 (and thus biasing the valve to a closed position). One benefit of this configuration is that when the body 100 is inserted into the opening of a container, the pressure of any air trapped inside the container can push against the plunger 902 so as to disengage the valve sealing member 904 from the wall portion 142 and allow such air to escape from the container (e.g. via the spout opening 108).

The flow control mechanism 900 includes an actuating member 112 for adjusting the position of the plunger 902 inside the body 100. In a representative embodiment, the actuating member 112 is moveable along a path that is substantially normal to the axis 300. As shown in FIG. 9A, the plunger 902 has an angled engaging surface 912 and the actuating member 112 has a correspondingly angled engaging surface 914. In this configuration, when the actuating member 112 moves towards the plunger 902 (e.g. in response to a user pushing the actuating member 112 in towards the body), the engaging surface 914 of the actuating member 112 pushes against the engaging surface of the plunger 902 and moves the plunger 902 (and valve sealing member 904) away from the wall portion 142 of the operating chamber 130. This configures the valve to an open position. The flow control mechanism 900 includes secondary biasing means for biasing the actuating member 112 to move away from the plunger 902 (e.g. when the user releases the actuating member 112). When the actuating member 112 moves away from the plunger 902, the primary biasing means 906 pushes the plunger 902 (and valve sealing member 904) towards the wall portion 142 (to configure the valve to a closed position), and also pushes the actuating member 112 away from plunger 902.

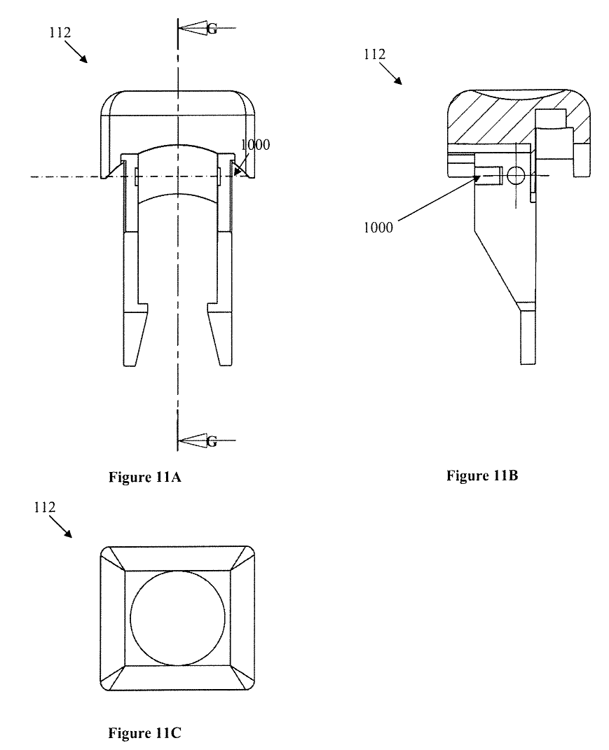

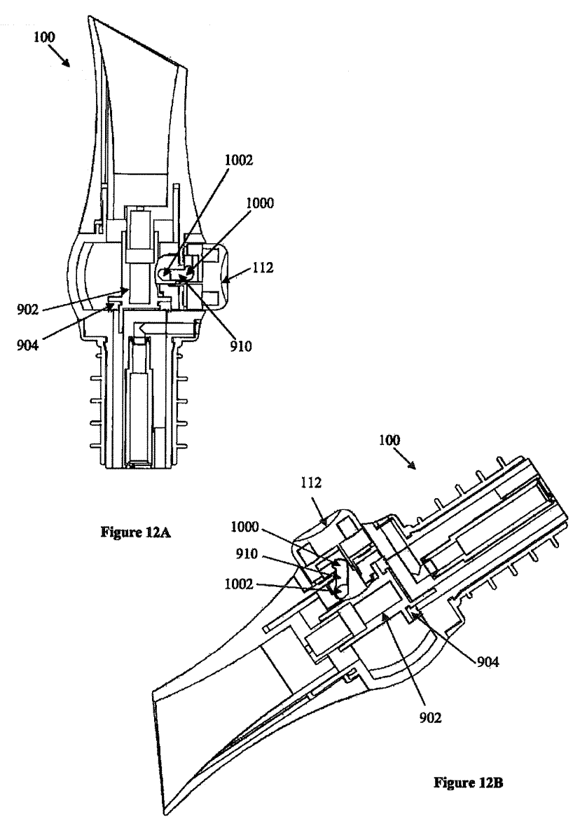

FIGS. 11A, 11B and 11C show a front view, cross-section view (along section G-G of FIG. 11A) and top view of the actuating member 112 according to a representative embodiment. It can be appreciated that the actuating member 112 can be replaced by any operating means for adjusting the position of the plunger 902 (and valve sealing member 904) relative to the wall portion 142. For example, the operating means may include a lever for adjusting the position of the plunger 902 inside the body 100.

In a representative embodiment, the flow control mechanism includes a lock member 910 that pivots about an axis 1000. The lock member 910 may have a weighted end 1002. The role of the lock member 910 can be better appreciated by reference to FIGS. 12A and 12B.

FIG. 12A is a cross-sectional view of the body 100 (along axis F-F in FIG. 3) when the body 100 is placed in an upright position (i.e. not in a pouring position). FIG. 12B is a cross-sectional view of the body 100 (along axis F-F in FIG. 3) when the body 100 is placed in a pouring position.

When the body 100 is not placed in a pouring position (as shown in FIG. 12A), the lock member 910 rotates about axis 1000 to a locking position between the actuating member 112 and plunger 902. When in the locking position, the lock member 910 resists the movement of the actuating member 112 towards plunger 902 so as to resist the movement of the plunger 902 (and valve sealing member 904) away from the wall portion 142 to adjust the valve to an open position. When the body 100 is placed in a pouring position (as shown in FIG. 12B), the lock member 910 rotates about axis 1000 to an unlocking position so that the actuating member 112 can move to the plunger 902 and adjust the valve to an open position.

Modifications and improvements to the invention will be readily apparent to those skilled in the art. Such modifications and improvements are intended to be within the scope of this invention.

In this specification where a document, act or item of knowledge is referred to or discussed, this reference or discussion is not an admission that the document, act or item of knowledge or any combination thereof was at the priority date, publicly available, known to the public, part of common general knowledge; or known to be relevant to an attempt to solve any problem with which this specification is concerned.

The word ‘comprising’ and forms of the word ‘comprising’ as used in this description and in the claims does not limit the invention claimed to exclude any variants or additions.

1. A liquid dispensing apparatus, including:
an expandable member for defining a first chamber and a second chamber in a cavity of a container, said first chamber being adapted for storing a liquid; and
a body having a passage formed through the body for accessing said first chamber, said body having a sealing portion for forming a seal around an opening to said cavity, said body having a valve that is selectively adjustable by a user to a closed position for inhibiting a flow of fluid through said passage;
wherein only when said body is placed in a pouring position, said valve is adjustable by a user to an open position to allow said liquid to be displaced from said first chamber via said passage when the second chamber expands.

2. An apparatus as claimed in claim 1 including:
a lock member moveable between a lock position and a unlock position;
wherein said lock member, when in said lock position, inhibits the adjustment of said valve from said closed position to said open position, and when said lock member is in said unlock position, said valve is adjustable from said closed position to said open position.

3. An apparatus as claimed in claim 2, wherein said lock member is moveable relative to said body by the force of gravity.

4. An apparatus as claimed in claim 2, wherein:
said lock member is rotatable about an axis; and
said lock member is rotatable from said lock position to said unlock position only when said body is placed in said pouring position.

5. An apparatus as claimed in claim 1, wherein said expandable member provides a barrier between said first and second chambers so as to inhibit the transfer of a substance between said first and second chambers.

6. An apparatus as claimed in claim 1, wherein said second chamber is inflatable with a substance external to said container.

7. An apparatus as claimed in claim 6, wherein said second chamber is coupled to a tubular conduit extending through a portion of said body.

8. An apparatus as claimed in claim 1, wherein said sealed formed by said sealing portion substantially inhibits a flow of gas between said sealing portion and said opening.

9. An apparatus as claimed in claim 8, wherein said seal is formed by an engagement of one or more flexible flange portions of said sealing portion with a surface around said opening of said container.

10. An apparatus as claimed in claim 9, wherein said one or more flexible flange portions are located on an exterior portion of said body and project away from said body.

11. An apparatus as claimed in claim 9, wherein said sealing portion is releasably coupled to said body.

12. An apparatus as claimed in claim 1, wherein said body includes:
a plunger located inside said body; and
a seal member coupled to said plunger;
such that when said valve is adjusted to said closed position, said plunger moves to a first position whereby the seal member engages a wall portion of said body to inhibit said flow through said passage of the body, and when said valve is adjusted to said open position, said plunger moves to a second position whereby the seal member is separated from said wall portion to enable said flow through said passage.

13. An apparatus as claimed in claim 12, wherein said body includes primary biasing means for biasing said plunger towards said first position.

14. An apparatus as claimed in claim 12, wherein said body includes:
operating means accessible from an exterior portion of said body;
wherein said operating means is operable by a user for engaging said plunger to move said seal member away from said portion of said body to allow said flow through the passage of said body.

15. An apparatus as claimed in claim 14, wherein:
said plunger includes a first flange portion; and
said operating means includes a second flange portion; and
said first and second flange portions being correspondingly angled so that, when said operating means moves towards said plunger, said first flange portion engages said second flange portion to move the seal member of said plunger away from said portion of said body to allow said flow through the passage of said body.

16. An apparatus as claimed in claim 14, wherein said body includes secondary biasing means for biasing said operating means away from said plunger to a rest position.
